(19) United States
(12) Patent Application Publication
(10) Pub. No.: US 2010/0036865 A1
(43) Pub. Date: Feb. 11, 2010

(54) Method For Generating Score-Optimal R-Trees

(75) Inventors: Jayavel SHANMUGASUNDARAM, Santa Clara, CA (US); Minos Garofalakis, San Francisco, CA (US); Erik Vee, San Mateo, CA (US); Ashwin Kumar Machanavajjhala, Ithaca, NY (US)

Correspondence Address: Yahoo! Inc., c/o Kenyon & Kenyon LLP, 333 W. San Carlos Street, Suite 600, San Jose, CA, 95110, US

(73) Assignee: Yahoo! Inc., Sunnyvale, CA (US)

(21) Appl. No.: 12/188,169

(22) Filed: Aug. 7, 2008

(51) Int. Cl. G06F 17/30

(52) U.S. Cl. 707/102; 707/E17.05

(57) ABSTRACT

A method of constructing a score-optimal R-tree to support top-k stabbing queries over a set of scored intervals generates a constraint graph from the set, and determines over each node in the constraint graph that has no other nodes pointing to it the node with the smallest left endpoint; for each of these nodes, the associated interval is added to the tree and the node is removed from the constraint graph.

### RELATED APPLICATION

This application is related to previously-filed U.S. patent application Ser. No. 11/932,928, filed Oct. 31, 2007, entitled SYSTEM AND/OR METHOD FOR PROCESSING EVENTS.

### BACKGROUND

1. Field of the Invention

Aspects of the present invention relate generally to processing events, and more specifically to generating a particular data structure to increase the efficiency of said processing.

2. Description of Related Art

The publish/subscribe (“pub/sub”) paradigm in which a large population of users expresses long-term interests (“subscriptions”) over streams of “published events” has gained immense popularity in recent years, due at least in part to the availability of increasing volumes of dynamic information available over the worldwide web such as, for example, stock quotes and news reports. A pub/sub engine typically matches an incoming event to a subset of standing subscriptions. For example, streams of event messages originating at one or more “publishers” may be matched with the interests of one or more pre-registered “subscribers. However, conventional methodologies rely on a simple binary notion of matching that assumes that each event either matches a subscription or does not, and many emerging applications require a more sophisticated notion of matching, where only the “best” matching subscriptions are of interest.

Thus, it is desirable to provide an efficient way to generate an index structure amenable to top-k stabbing queries.

### SUMMARY

In light of the foregoing, it is a general object of the present invention to provide an efficient method for creating an index structure to store scored intervals corresponding to subscriptions, which index structure is amendable to top-k stabbing queries.

### BRIEF DESCRIPTION OF THE DRAWING FIGURES

FIG. 1A is an example set of scored intervals.

FIG. 1B is a simplified representation of an R-Tree.

FIG. 1C is a typical binary-tree representation of the R-Tree shown in FIG. 1B.

FIG. 2A is a simplified representation of a scored R-Tree.

FIG. 2B is a typical binary-tree representation of the scored R-Tree shown in FIG. 2A.

FIG. 3 is a logical flowchart of the general process by which a constraint graph may be generated according to an embodiment of the invention.

FIG. 4A is a simplified representation of a constraint graph.

FIG. 4B is a simplified representation of a score-optimal R-tree.

FIG. 4C is a typical binary-tree representation of the score-optimal R-tree shown in FIG. 4B.

FIG. 5 is a logical flowchart of the general process by which a constraint graph may be generated according to an embodiment of the invention.

FIG. 6 is a logical flowchart of the general process by which a score-optimal R-tree may be generated according to an embodiment of the invention.

### DETAILED DESCRIPTION

Detailed descriptions of one or more embodiments of the invention follow, examples of which may be graphically illustrated in the drawings. Each example and embodiment is provided by way of explanation of the invention, and is not meant as a limitation of the invention. For example, features described as part of one embodiment may be utilized with another embodiment to yield still a further embodiment. It is intended that the present invention include these and other modifications and variations.

Aspects of the present invention are described below in the context of providing an efficient way of representing scored intervals such that they may be retrieved in response to a stabbing query.

Publish/subscribe (pub/sub) systems are designed to efficiently match incoming events (e.g., stock quotes) against a set of subscriptions (e.g., trader profiles specifying quotes of interest). However, current pub/sub systems support only binary matching (i.e., either it matches or it does not); for example, a stock quote will either match or not match a trader profile. This simple notion of matching is inadequate for many applications where only the “best” matching subscriptions are of interest.

For example, in targeted Web advertising, an incoming user (“event”) may match several different advertiser-specified user profiles (“subscriptions”), but given the limited advertising real-estate, it is desired to quickly discover only the best (e.g., most relevant, etc.) ads to display. As a more specific example, consider a mortgage vendor who wishes to show an ad tailored to users between 20 and 35 years of age, with credit scores between 400 and 500, and who have visited a real-estate web site at least three times in the past month. Such a goal can be modeled as a pub/sub problem, where the stream of incoming users corresponds to events (e.g., a user with age=25, credit score=441, and real estate web site visit count=6), and the advertiser specifications are subscriptions (e.g., 20≦age≦35 and 400≦credit score≦500 and real estate count≧3). However, unlike traditional pub/sub systems, it is not desired to retrieve all the subscriptions (ads) that correspond to a given event (user), because only a small number of ads can be shown on the web page. Rather, it is desired to retrieve the “best” subscriptions based on some criteria such as the most targeted ads, the most profitable ads, the most underserved ads, etc.

Online job sites provide another good example. Such sites generally allow job seekers to register profiles, and job posters to specify job seeker profiles in which they are interested. For instance, a job seeker may register a profile for nursing jobs that pay $50/hour and require 25-hours/week; and a job poster may express an interest in nurses who are willing to work between 20 and 30 hours/week for $45-60/hour. Thus, when a job seeker visits the site, she can be presented with jobs that match her profile. This can again be modeled as a pub/sub problem, where the events are job seekers (e.g., job type=nursing, hourly rate=$50 and hours/week=25) and the subscriptions are job poster interests (e.g., job type=nursing, 45≦hourly rate≦60, and 20≦hours/week≦30). However, as in the targeted advertising case, it is likely that all the jobs that match a user profile cannot be shown because of the web page's limited real estate. Therefore, it is again desired to retrieve only the best jobs for a given user based on criteria such as the monetary value to the job poster, fairness of exposure across job postings, etc.

Throughout this disclosure, subscriptions correspond to interval ranges (e.g., age in [25, 35] and salary>$50,000), and are hereafter referred to as such. In addition, each interval has a score, and the goal is to quickly recover the top-scoring matching subscriptions. Unfortunately, adapting existing index structures to solve this problem results in either an unacceptable space overhead or significant performance degradation, and thus new index structures are needed.

As is known in the art, there are many existing interval index structures, including the R-tree, which are designed to support interval stabbing queries (i.e., queries that return the set of all intervals that are stabbed by a given query point). However, it is an object of the present invention to gather the top-k interval stabbing queries (i.e., queries that return the top-k scoring intervals that are stabbed by a query point), and such existing index structures are either time or space-inefficient for this type of application.

Given the goal of producing the top-k matching subscriptions (as opposed to returning all matching subscriptions and then performing some post-processing to get the top-k results), the main technical challenge is devising efficient scored interval indices. Existing interval index structures such as interval trees, segment trees and (1-dimensional) R-trees are not directly applicable to the problem because they do not produce results in score order, though they can be adapted to produce such results, as described in related U.S. Ser. No. 11/932,928.

In fact, the present invention may be implemented as a particular R-tree, which relies on an intelligent pre-processing of the underlying scored interval set before indexing it. Before describing the present invention, some context regarding the prior art is provided. Generally, the input used for the remainder of this disclosure comprises a collection of n intervals Γ, where each interval Iᵢ ∈ Γ is a pair of left/right endpoints (Iᵢ=[xᵢ^{l},xᵢ^{r}],i=1, . . . ,n).

Conventionally, R-trees have been used for indexing hyperrectangles in order to efficiently search for all rectangles that overlap with a query rectangle. In a single dimension, intervals “overlap” a query point q if and only if they are stabbed by q. Hence, R-trees can be used to solve the problem at hand. Generally, an R-tree groups intervals into partitions of size≦b , where b is the branching factor. Various heuristics can be used for grouping intervals, including minimizing the size of the bounding interval for a group, minimizing bounding interval overlap between groups, grouping intervals by their start or end points, etc.

Each group of intervals is stored in a leaf node of the R-tree, and the leaf node is associated with an extent interval which is the minimum bounding interval of the intervals in the leaf node. For example, suppose [lᵢ^{g},rᵢ^{g}],i=1, . . . ,b, are the intervals in a leaf node g, then I_{g}=[l^{g},r^{g}], where l_{g}=minᵢ lᵢ^{g} and r^{g}=maxᵢ rᵢ^{g} is the minimum bounding interval. The R-tree is constructed recursively on these minimum bounding intervals, and a child pointer is added from the entry corresponding to interval I_{g} to the leaf node g. In order to answer a stabbing query q, child pointers may be continually chased (starting from the root node) as long as q is in the extent interval of each intermediate node. When a leaf node is reached, the set of intervals that contain q is returned.

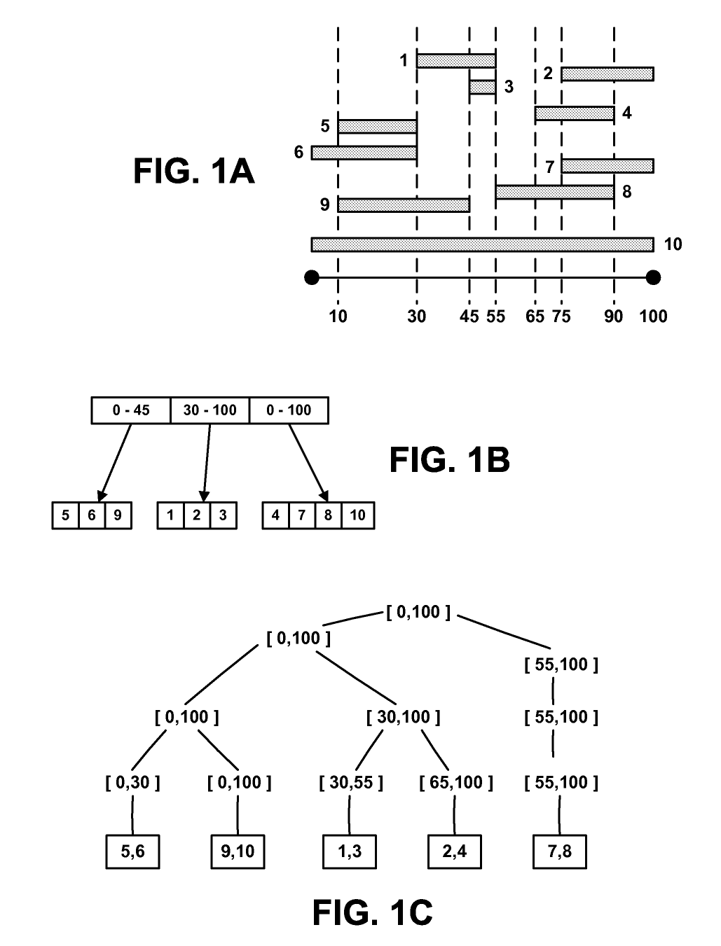

FIG. 1 illustrates example intervals indexed by an R-Tree with a branching factor of four. The leaf nodes partition the intervals into groups of at most four, and each entry in the root node is a minimum bounding interval of the leaf nodes. The interval set is shown in FIG. 1A, and the interval set is shown grouped, in the simplified R-tree representation of FIG. 1B, so as to try and minimize the size of the bounding intervals. Finally, FIG. 1C illustrates a typical binary-tree representation of this particular R-tree. It will be appreciated that the R-Trees shown in FIGS. 1B-C are not especially “good,” given that, for example, a query of 35 would require every node in the R-Tree to be visited.

R-trees have the flexibility to group intervals together based on certain criteria, and in order to answer top-k stabbing queries, it is natural to group intervals by their scores so that the top scored intervals are grouped together, the next lower scored intervals are grouped together, and so on. In other words, a scored R-tree orders intervals in decreasing order of their scores and picks consecutive blocks of size b to form the leaf node groups. Recursively, if (g₁, . . . ,gₖ) are the set of internal nodes at any level of the R-tree (in that order), then every interval in the subtree of g₁ has a score at least as large as that of every interval in the subtree of g₂. Starting from the root node of a scored R-tree, a stabbing query q may be answered by, at each internal node, scanning each entry from left to right and recursing on its child node only if its extent interval contains the query point q. At a leaf node, the intervals are scanned from left to right and an interval is recorded if it is stabbed by q. The recursive call is returned from if either all entries in the node have been processed or if k intervals have been recorded.

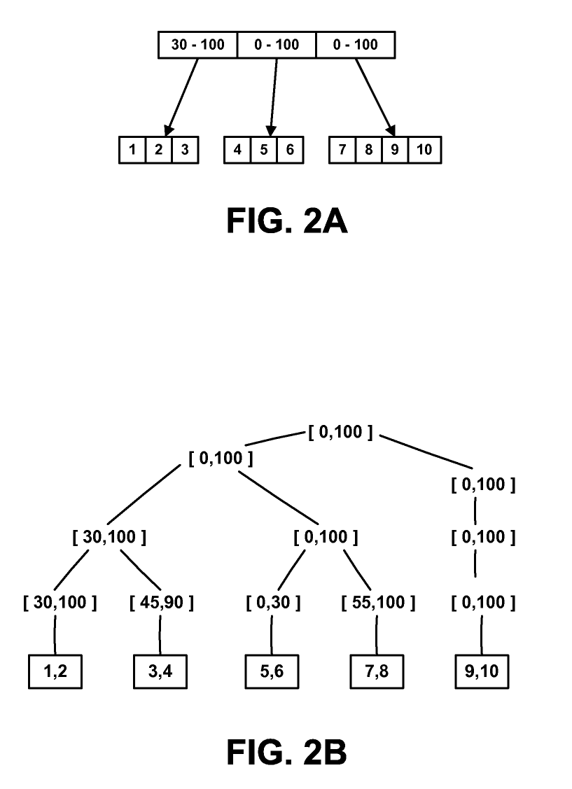

FIG. 2 illustrates the example interval set from FIG. 1A as indexed by a scored R-tree with a branching factor of four. The interval set used in FIG. 2 is the same set shown in FIG. 1A, except now the intervals have scores, the scores corresponding to the intervals' top-to-bottom ordering on the y-axis (i.e., interval 1 has a higher score than interval 2, interval 2 has a higher score than interval 3, etc.). FIG. 2A illustrates a simplified scored R-tree representation of the scored interval set shown in FIG. 1A. FIG. 2B illustrates a typical binary-tree representation of the scored R-tree shown in FIG. 2A.

As just discussed, the intervals in a scored R-tree are sorted by their scores, and the R-tree is built on top of these scored intervals. For many distributions, this approach will produce a large number of “holes,” leading to poor performance, but by rearranging the intervals in a certain manner, most holes can be avoided and query times increased.

Such an approach to building the scored R-tree is a principle of the present invention, which stems from the following insight. Suppose that I₁ and I₂ are intervals to be indexed. Suppose further that the score of I₁ is greater than the score of I₂, and that no interval has a score between the score of I₁ and the score of I₂. If I₁ and I₂ intersect, then any R-tree indexing them must place I₁ before I₂. However, if I₁ and I₂ do not intersect, they are free to be placed in either order, since no query point can stab both intervals (i.e., their relative ordering is immaterial).

To build a scored R-tree that takes into account the property just described, a constraint graph may be defined for the intervals, which captures the allowable arrangements of intervals. Given an interval set and a constraint graph, the optimal arrangement for a scored R-Tree may be found.

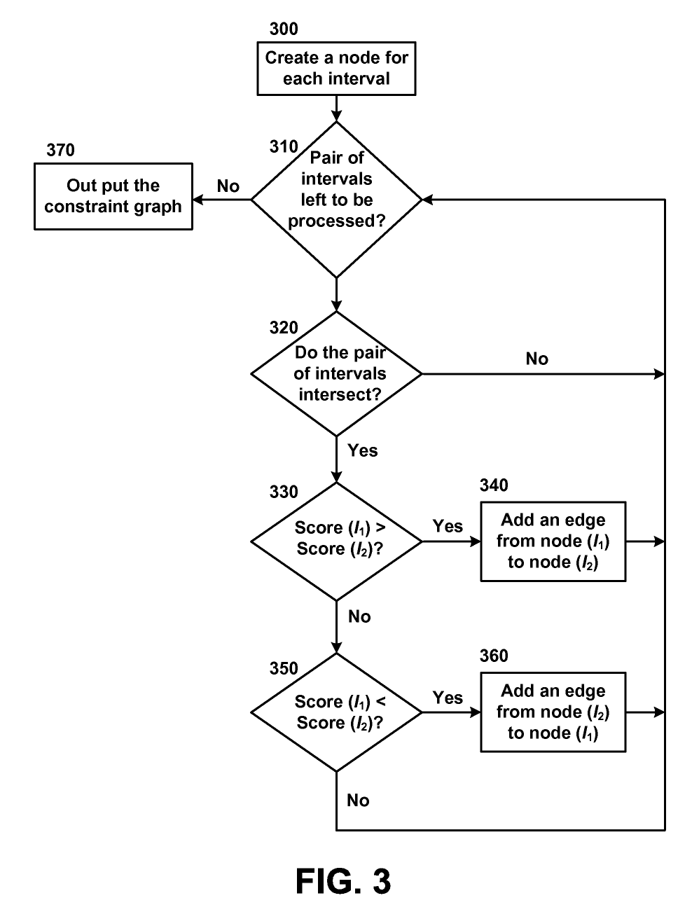

To understand the concept of the constraint graph, consider the set Γ of n input intervals, each with an associated score, and let \tilde{G}(Γ) be the directed graph (V,\tilde{E}), where V and \tilde{E} are as follows: the set V consists of n nodes, one for each interval I ∈ Γ. The node associated with I is referred to by node(I). An edge is included in \tilde{E} from node(I₁) to node(I₂) if and only if I₁ ∩I₂≠0 and score (I₁)>score (I₂). This approach is further illustrated by FIG. 3. At block 300, a graph node is created for each of the scored intervals in the interval set, though there are no edges yet between them. For each pair of scored intervals in the interval set (block 310), it is determined whether the pair of scored intervals intersect (block 320), and if so, which of the two scored intervals in the pair has the higher score (blocks 330 and 350). Depending on which of the scores between the pair is greater, an edge will be added either from node(I₁) to node(I₂) (i.e., the scored interval associated with node(I₁) has a greater score than the scored interval associated with node(I₂)), or from node(I₂) to node(I₁), as illustrated at blocks 340 and 360. If the scores between the pair of intervals are equal to each other, then any one of multiple paths may be taken. For example, it may be decided that in the case of equal scores, no edge will be added between the pair. Alternatively, a tie-breaking rule may be implemented; for example, the scored interval occurring at the left-most, lefthand endpoint may be selected as the head of the edge between the pair, etc. At block 370, the constraint graph is returned after it has been determined, at block 310, that all scored interval pairs have been processed.

In another embodiment, and in an effort to avoid some extraneous “transitive” edges, a couple of other steps may be taken when constructing the constraint graph. First, graph G=(V,E) may be defined to have the same vertex set as \tilde{G}. Second, E may be defined as follows. If I₁,I₂ ∈ Γ with score(I₁)>score(I₂ ), then E contains an edge from node(I₁) to node(I₂) if and only if (a) I₁ ∩ I₂≠0; and (b) there exists a point q ∈ I₁ ∩ I₂ such that, for all I ∈ Γ with score(I₁)>score(I)>score(I₂), the point q ∉ I. It will be appreciated that such a graph contains only a subset of the edges in \tilde{G}, and that if there is an edge from node(I₁) to node(I₂) in \tilde{E}, then there is a path from node(I₁) to node(I₂) in E.

It can thus be said that an arrangement of the scored intervals in Γ respects G(Γ) if for all scored intervals I₁,I₂ ∈ Γ such that there is an edge from node(I₁) to node(I₂), the scored interval I₁ comes before I₂ in the arrangement. By the fact that that edges in \tilde{G}(Γ) always map to paths in G(Γ), an arrangement respects G(Γ) if and only if it respects \tilde{G}(Γ).

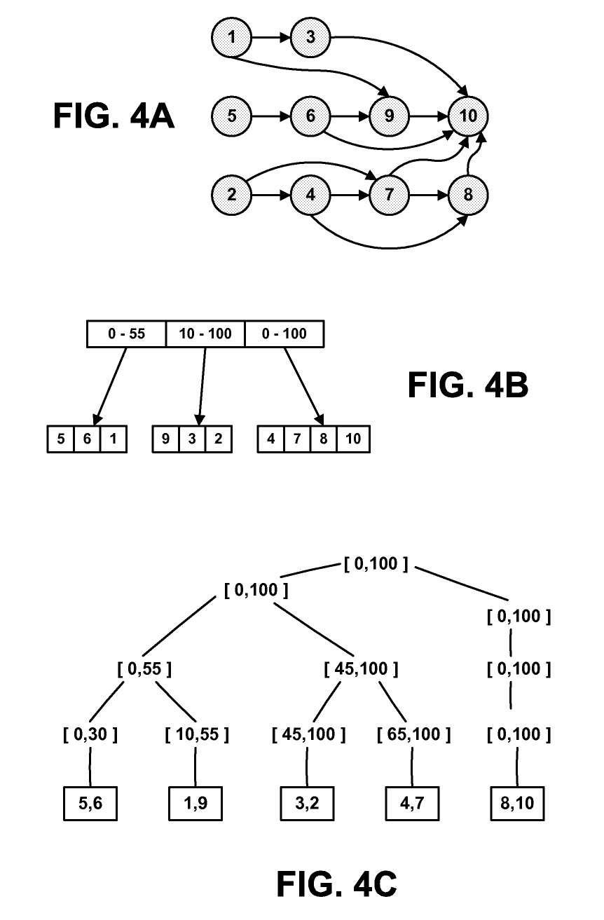

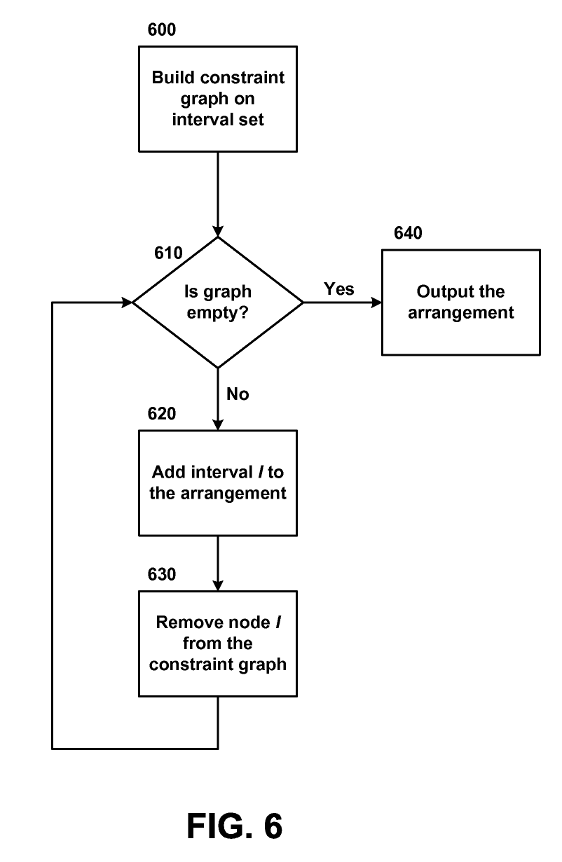

FIG. 4A illustrates an example constraint graph based on the scored intervals discussed earlier in conjunction with FIG. 2, which shows, for example, that scored interval 1 intersects scored intervals 3 and 9, and score(1)>score(3) and score(1)>score(9); moreover, 1 ∩ 3 and 1 ∩ 9 do not intersect any other scored intervals of intermediate scores. Hence, edges (1, 3) and (1, 9) appear in the constraint graph shown in FIG. 4A. Even though scored interval 1 also intersects scored interval 10 and score(1)>score(10), there is no edge (1, 10) shown in the constraint graph of FIG. 4A; however, this edge is “covered” by the (1, 3,10) path in the constraint graph. FIG. 4B illustrates a simplified score-optimal R-tree representation of the scored interval set shown in FIG. 1A and based on the constraint graph shown in FIG. 4A (such score-optimal R-tree being constructed using a process defined by, for example, the flowchart illustrated in FIG. 6). FIG. 4C illustrates a typical binary-tree representation of the score-optimal R-tree shown in FIG. 4B.

In another embodiment, the construction of the constraint graph may make use of an additional concept—“visible blocks”—which concept is explained below. Given a subset K ∩ Γ of scored intervals, let an endpoint p be visible with respect to K if (a) there is some interval I ∈ K for which p is an endpoint; and (b) there is no other interval J ∈ K with score(I)>score(J) and p ∈ J. In an effort to better explain the concept of visible blocks, it may be helpful to consider again the example intervals shown in FIG. 1A, recalling that the intervals are ordered by decreasing score. Imagine looking upward from below the intervals; if K consists of the intervals 1 through 10, then the point p=30 is not a visible endpoint with respect to K—intuitively, interval 10 may be thought of as obscuring it. However, if K consists of the intervals 1 through 8, then p=30 is a visible endpoint with respect to K (i.e., 30 is an endpoint of interval 6, and no lower-scoring interval contains (or “obscures”) 30).

The set of endpoints that are visible with respect to K, break the real line into intervals, and these intervals are the “visible blocks,” said blocks hereinafter referred to as visBlks(K), wherein set visBlks(0) contains only the interval(−∞,∞). For each block B ∈ visBlks(K), it is said that interval I ∈ K is associated with B if I is the lowest scoring interval in K such that B ∩ I.

Referring again to FIG. 2A, visBlks({1,2, . . . ,7}) consists of the blocks (−∞, 0], [0, 30], [30, 45], [45, 55], [55, 65], [65, 75], [75, 100], and [100, ∞). Interval 6 is associated with block [0, 30]. Interval 1 is associated with block [30, 45], interval 3 with [45, 55], interval 4 with [65, 75], and interval 7 with [75, 100]. Blocks (1, 30], [55, 65], and [100, 1) have no associated intervals. Notice that each block has at most one interval associated with it.

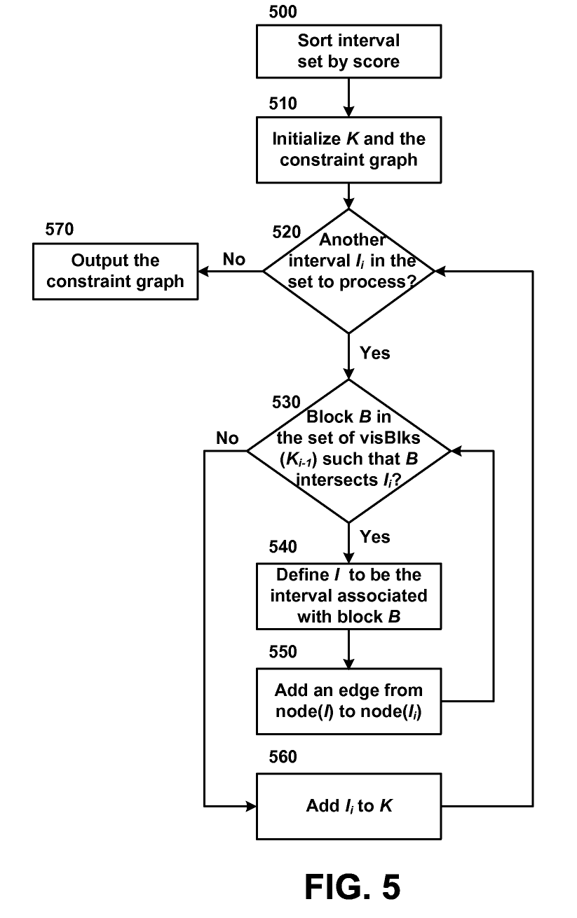

FIG. 5 is a flowchart outlining how a constraint graph may be built according to an embodiment of the invention. The constraint graph's construction takes advantage of a key property, namely that when considering the ith interval Iᵢ, only the set of visible blocks that Iᵢ intersects needs to be found in order to find all edges pointing to node(Iᵢ) in the constraint graph.

For convenience, assume that Γ, the set of scored intervals, contains the interval (−∞,∞) with score ∞, so that every visible block will have an associated interval. At block 500, the intervals in Γ are sorted in decreasing order of their scores, say I₁,I₂, . . . . At block 510, K and the constraint graph G(Γ) are initialized; K←{I₁}, and G(Γ) gets a node for each interval, with no edges yet between them. For each interval Iᵢ other than I₁ (block 520), it is determined if there are blocks left to process in the set of visible blocks from visBlks(Kᵢ₋₁) that intersect Iᵢ, as illustrated at block 530. To the extent that visBlks(Kᵢ₋₁) is not empty to begin with or, if non-empty, not every block B has been processed, an interval I is defined to be the interval associated with each block B, as shown at block 540. Once the association between block B and I has been made, an edge is added to the constraint graph G(Γ) from node(I) to node (Iᵢ), as illustrated at block 550. After this edge has been added, control returns to block 530, which checks to see if there are any more blocks B to process, and if so, blocks 540 and 550 are again invoked; if not, block 560 is reached and Iᵢ is added to K. After all the blocks B in the set of visible blocks from visBlks(Kᵢ₋₁) that intersect Iᵢ are processed, control is returned to block 520, which determines if there are intervals left to process, and if so cedes control to block 530 which carries on as described above. If all of the intervals in Γ have been processed (block 520), the constraint graph is returned, as illustrated at block 570.

In an embodiment, the set of visible endpoints with respect to K, sorted by value, may be maintained during construction of the constraint graph (using, for example, a tree). Given interval Iᵢ, let x be its left endpoint and y its right endpoint. To maintain the list of visible endpoints when interval Iᵢ is added to K (block 560), x and y are inserted and all previously visible endpoints that lie between x and y are removed.

Once a constraint graph has been generated, intervals can be grouped together in terms of their spatial proximity by exploiting the partial-ordering constraints specified in the constraint graph. FIG. 6 is a flowchart outlining how an optimum interval arrangement of a scored R-tree—a score-optimal R-tree—can be built according to an embodiment of the invention. At block 600, a constraint graph for a set of scored intervals is constructed according to, for example, the flowchart of FIG. 5. Once the constraint graph has been generated, the nodes of the constraint graph are traversed, as shown at block 610, until the graph is empty (i.e., until it has no remaining nodes, which are removed at block 630, as described below). If, at block 610, it is determined that the constraint graph is not empty, a couple of things occur. First, at block 620, interval I is added to the arrangement to be output, where interval I is defined to be the interval with the smallest left endpoint value, taken over all intervals which have node(I) with indegree 0. Second, node(I) is removed from the constraint graph, as illustrated at block 630. When it is later determined, at block 610, that the constraint graph is empty, the arrangement is output, as shown at block 640. Thus, for any set Γ of scored intervals, the b-way score-optimal R-tree for Γ may be defined as the b-way scored R-tree created using the arrangement produced by the flowchart outlined in FIG. 6.

The sequence and numbering of blocks depicted in FIGS. 3, 5, and 6 is not intended to imply an order of operations to the exclusion of other possibilities. Those of skill in the art will appreciate that the foregoing systems and methods are susceptible of various modifications and alterations.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of constructing a tree to support stabbing queries for a plurality of scored intervals, said method comprising:
generating a constraint graph from the plurality of scored intervals, wherein each node of the constraint graph is associated with one of the plurality of scored intervals;
determining, over the nodes in the constraint graph which have no other nodes pointing to them, the node whose associated scored interval contains the smallest left endpoint;
in response to said determining:
adding the scored interval which contains the smallest left endpoint to the tree; and
removing, from the constraint graph, the node whose associated scored interval contains the smallest left endpoint;
said method further comprising repeating said determining, said adding, and said removing until each of the plurality of nodes is removed.

2. The method of claim 1 wherein said generating comprises:
for each pair of scored intervals whose intervals intersect, including an edge in the constraint graph from the node associated with the interval with the greater score to the node associated with the interval with the lesser score.

3. The method of claim 1 wherein said generating comprises:
for each scored interval pair that intersects:
determining whether there is a point contained by the intersection such that for each of the plurality of scored intervals other than the pair:
the score of said each scored interval is greater than the score of the first scored interval in the pair and less than the score of the second scored interval in the pair; and
the point is not contained by said each scored interval;
responsive to a determination that there is such a point, including an edge in the constraint graph from the node associated with the first scored interval in the pair to the node associated with the second scored interval in the pair.

4. The method of claim 1 wherein said generating comprises:
sorting the plurality of scored intervals in descending order by score;
creating a subset of the sorted plurality of scored intervals, wherein the subset comprises initially only the first scored interval in the sorted plurality of scored intervals;
for each scored interval i in the sorted plurality of scored intervals other than the first scored interval, in order of decreasing score:
for each visible block b in the subset that intersects scored interval i:
defining an interval x to be the interval associated with the respective block b; and
including an edge in the constraint graph from the node associated with the respective interval x to the node associated with the respective scored interval i;
adding the scored interval i to the subset.

5. The method of claim 4 wherein said adding further comprises removing all previously visible endpoints which lie between the endpoints of the scored interval i.

6. The method of claim 4 wherein the set of visible endpoints with respect to the subset is maintained using a tree.

7. A computer-readable medium encoded with a set of instructions which, when performed by a computer, perform a method of constructing a tree to support stabbing queries for a plurality of scored intervals, said method comprising:
generating a constraint graph from the plurality of scored intervals, wherein each node of the constraint graph is associated with one of the plurality of scored intervals;
determining, over the nodes in the constraint graph which have no other nodes pointing to them, the node whose associated scored interval contains the smallest left endpoint;
in response to said determining:
adding the scored interval which contains the smallest left endpoint to the tree; and
removing, from the constraint graph, the node whose associated scored interval contains the smallest left endpoint;
said method further comprising repeating said determining, said adding, and said removing until each of the plurality of nodes is removed.

8. The computer-readable medium of claim 7 wherein said generating comprises:
for each pair of scored intervals whose intervals intersect, including an edge in the constraint graph from the node associated with the interval with the greater score to the node associated with the interval with the lesser score.

9. The computer-readable medium of claim 7 wherein said generating comprises:
for each scored interval pair that intersects:
determining whether there is a point contained by the intersection such that for each of the plurality of scored intervals other than the pair:
the score of said each scored interval is greater than the score of the first scored interval in the pair and less than the score of the second scored interval in the pair; and
the point is not contained by said each scored interval;
responsive to a determination that there is such a point, including an edge in the constraint graph from the node associated with the first scored interval in the pair to the node associated with the second scored interval in the pair.

10. The computer-readable medium of claim 7 wherein said generating comprises:
sorting the plurality of scored intervals in descending order by score;
creating a subset of the sorted plurality of scored intervals, wherein the subset comprises initially only the first scored interval in the sorted plurality of scored intervals;
for each scored interval i in the sorted plurality of scored intervals other than the first scored interval, in order of decreasing score:
for each visible block b in the subset that intersects scored interval i:
defining an interval x to be the interval associated with the respective block b; and
including an edge in the constraint graph from the node associated with the respective interval x to the node associated with the respective scored interval i;
adding the scored interval i to the subset.

11. The computer-readable medium of claim 10 wherein said adding further comprises removing all previously visible endpoints which lie between the endpoints of the scored interval i.

12. The computer-readable medium of claim 10 wherein the set of visible endpoints with respect to the subset is maintained using a tree.
